(19) United States
(12) Patent Application Publication
(10) Pub. No.: US 2015/0192404 A1
(43) Pub. Date: Jul. 9, 2015

(54) REDUCING REGISTRATION ERROR OF FRONT AND BACK WAFER SURFACES UTILIZING A SEE-THROUGH CALIBRATION WAFER

(71) Applicant: KLA-Tencor Corporation, Milpitas, CA (US)

(72) Inventors: Shouhong Tang, Santa Clara, CA (US); Andrew Zeng, Fremont, CA (US); Chunhai Wang, Pleasanton, CA (US); Yaroslov Dudin, San Jose, CA (US); Steve Yifeng Cui, Fremont, CA (US); Jei-Fei Zheng, Fremont, CA (US); Yi Zhang, Sunnyvale, CA (US)

(21) Appl. No.: 14/661,718

(22) Filed: Mar. 18, 2015

Related U.S. Application Data
(63) Continuation of application No. PCT/US2014/032261, filed on Mar. 28, 2014.
(60) Provisional application No. 61/806,935, filed on Apr. 1, 2013.

(51) Int. Cl. G01B 9/02; G01B 11/24; G01B 11/02

(52) U.S. Cl. CPC G01B 9/02072; G01B 11/02; G01B 11/2441

(57) ABSTRACT

A calibration wafer and a method for calibrating an interferometer system are disclosed. The calibration method includes: determining locations of the holes defined in the calibration wafer based on two opposite intensity frame; comparing the locations of the holes against the locations measured utilizing an external measurement device; adjusting a first optical magnification or a second optical magnification at least partially based on the comparison result; defining a first distortion map for each of the first and second intensity frames based on the comparison of the locations of the holes; generating an extended distortion map for each of the first and second intensity frames by map fitting the first distortion map; and utilizing the extended distortion map for each of the first and second intensity frames to reduce at least one of: a registration error or an optical distortion in a subsequent measurement process.

### CROSS-REFERENCE TO RELATED APPLICATIONS

This application is filed under 35 U.S.C. §111(a) and §365(c) as a continuation of International Patent Application No. PCT/US2014/032261, filed on Mar. 28, 2014, which application claims the benefit of U.S. Provisional Patent Application No. 61/806,935, filed on Mar. 31, 2013, which applications are incorporated herein by reference in their entireties.

### TECHNICAL FIELD

The disclosure generally relates to the field of measuring technology, particularly to methods for wafer shape and thickness measurement.

### BACKGROUND

Thin polished plates such as silicon wafers and the like are a very important part of modern technology. A wafer, for instance, refers to a thin slice of semiconductor material used in the fabrication of integrated circuits and other devices. Other examples of thin polished plates may include magnetic disc substrates, gauge blocks and the like.

Generally, certain requirements may be established for the flatness and thickness uniformity of the wafers. There exist a variety of techniques to address the measurement of shape and thickness variation of wafers. One such technique is disclosed in U.S. Pat. No. 6,847,458, which is capable of measuring the surface height on both sides and thickness variation of a wafer. It combines two phase-shifting Fizeau interferometers to simultaneously obtain two single-sided distance map between each side of a wafer and corresponding reference flats, and computes thickness variation and shape of the wafer from the data and calibrated distance map between two reference flats.

The measurement directly obtained from a Fizeau interferometer is a wafer surface height map relative to the reference flat. Two of such maps, one from each channel, are combined to compute the thickness variation and the shape of a wafer. The registration accuracy of these two maps or the front side and the backside of a wafer play a very important role in the measurement. The method currently implemented uses the wafer boundary extracted on the oversized cavity area from both channels to register the front and the back side of wafer surfaces. Such registration may be inaccurate both in the rotational direction since the wafer is a circular shape and the notch is very small, and in the x- the y-direction since the wafer center is determined by the wafer edge that may be misplaced by the optical geometric distortion. Any registration error will prevent measurement accuracy from meeting stringent demands of future industry requirements.

### SUMMARY OF THE INVENTION

The present invention comprises an interferometer system having first and second spaced apart reference flats having corresponding first and second parallel reference surfaces forming a cavity therebetween, first and second interferometer devices located on diametrically opposite sides of the cavity, first and second interferogram detectors, and, at least one processing unit coupled to receive outputs of the first and second interferogram detectors, the at least one processing unit configured for performing a method for calibrating the interferometer system based on first and second intensity frames of a calibration wafer obtained from the first and second interferogram detectors, the method including a) determining first locations of a plurality of holes based on the first intensity frame, b) determining second locations of the plurality of holes based on the second intensity frame, c) comparing the first locations of the plurality of holes determined based on the first intensity frame and the second locations of the plurality of holes determined based on the second intensity frame against first measured locations of the plurality of holes measured utilizing an external measurement device, d) adjusting at least one of a first optical magnification of a first interferometer channel or a second optical magnification of a second interferometer channel at least partially based on said comparison, e) defining a first distortion map for each of the first and second intensity frames based on said comparison, f) generating an extended distortion map for each of the first and second intensity frames by map fitting the first distortion map defined in step e), and, g) utilizing the extended distortion map for each of the first and second intensity frames to reduce at least one of a registration error or an optical distortion in a subsequent measurement process

The present invention also comprises an interferometer system having first and second spaced apart reference flats having corresponding first and second parallel reference surfaces forming a cavity therebetween, first and second interferometer devices located on diametrically opposite sides of the cavity, first and second interferogram detectors, and, at least one processing unit coupled to receive outputs of the first and second interferogram detectors, the at least one processing unit configured to acquire a first intensity frame of a calibration wafer from a first interferometer channel and acquiring a second intensity frame of the calibration wafer from a second interferometer channel, wherein the calibration wafer defines a plurality of circular shapes therein, determine locations of the plurality of circular shapes based on the first intensity frame of the calibration wafer and the second intensity frame of the calibration wafer, acquire a third intensity frame of a measuring wafer from the first interferometer channel and acquiring a fourth intensity frame of the measuring wafer from the second interferometer channel, and, register relative positions of the third intensity frame of the measuring wafer and the fourth intensity frame of the measuring wafer based on the determined locations of the plurality of circular shapes.

The present invention also comprises a method for calibrating an interferometer system, the interferometer system including a cavity formed between reference flats in a first interferometer channel and a second interferometer channel, the method including a) placing a calibration wafer in the cavity, the calibration wafer defining a plurality of holes therein, b) acquiring a first intensity frame from the first interferometer channel, c) acquiring a second intensity frame from the second interferometer channel, d) determining first locations of the plurality of holes based on the first intensity frame, e) determining second locations of the plurality of holes based on the second intensity frame, f) calculating a first distance between a first pair of holes of the plurality of holes based on the first intensity frame, g) calculating a second distance between the first pair of holes based on the second intensity frame, h) comparing the first calculated distance and the second calculated distance against a first measured distance between the first pair of holes, i) adjusting at least one of a first optical magnification of the first interferometer channel or a second optical magnification of the second interferometer channel based on said comparison in step h), j) defining a first distortion map for each of the first and second intensity frames based on said comparison of the first and second locations of the plurality of holes, k) generating an extended distortion map for each of the first and second intensity frames by map fitting the first distortion map defined in step h), and, l) utilizing the extended distortion map for each of the first and second intensity frames to reduce at least one of a registration error or an optical distortion in a subsequent measurement process.

The present invention also comprises a method for calibrating an interferometer system, the interferometer system including a cavity formed between reference flats in a first interferometer channel and a second interferometer channel, the method including a) placing a calibration wafer in the cavity, the calibration wafer defining a plurality of holes therein, b) acquiring a first intensity frame from the first interferometer channel, c) acquiring a second intensity frame from the second interferometer channel, d) determining first locations of the plurality of holes based on the first intensity frame, e) determining second locations of the plurality of holes based on the second intensity frame, f) comparing the first locations of the plurality of holes determined based on the first intensity frame and the second locations of the plurality of holes determined based on the second intensity frame against measured locations of the plurality of holes measured utilizing an external measurement device, g) adjusting at least one of a first optical magnification of the first interferometer channel or a second optical magnification of the second interferometer channel at least partially based on said comparing step, h) defining a first distortion map for each of the first and second intensity frames based on said comparing step, i) generating an extended distortion map for each of the first and second intensity frames by map fitting the first distortion map defined in step h), and, j) utilizing the extended distortion map for each of the first and second intensity frames to reduce at least one of a registration error or an optical distortion in a subsequent measurement process.

The present invention also comprises a method for wafer measurement, the method including calibrating characteristics of a cavity formed between reference flats in two opposing interferometer channels, placing a calibration wafer in the cavity, the calibration wafer defining a plurality of circular shapes therein, acquiring a first intensity frame of the calibration wafer from the first interferometer channel and acquiring a second intensity frame of the calibration wafer from the second interferometer channel, determining locations of the plurality of circular shapes based on the first intensity frame of the calibration wafer and the second intensity frame of the calibration wafer, placing a measuring wafer in the cavity, acquiring a third intensity frame of the measuring wafer from the first interferometer channel and acquiring a fourth intensity frame of the measuring wafer from the second interferometer channel, and, registering relative positions of the third intensity frame of the measuring wafer and the fourth intensity frame of the measuring wafer based on the determined locations of the plurality of circular shapes.

The present invention also comprises a method for wafer measurement, the method including calibrating characteristics of a cavity formed between reference flats in two opposing interferometer channels, placing a measuring wafer in the cavity, placing at least one reference plate in the cavity, acquiring a first intensity frame from the first interferometer channel and acquiring a second intensity frame from the second interferometer channel, and, registering relative positions of the first intensity frame and the second intensity frame based on at least one position of the at least one reference plate.

The present disclosure is directed to a method for calibrating an interferometer system. The interferometer system includes a cavity formed between reference flats in a first interferometer channel and a second interferometer channel. The calibration method includes placing a calibration wafer in the cavity, the calibration wafer defining a plurality of holes therein, acquiring a first intensity frame from the first interferometer channel, acquiring a second intensity frame from the second interferometer channel, determining locations of the plurality of holes based on the first intensity frame, determining locations of the plurality of holes based on the second intensity frame, calculating a first distance between a pair of holes of the plurality of holes based on the first intensity frame, calculating a second distance between the same pair of holes based on the second intensity frame, comparing the first calculated distance and the second calculated distance against a measured distance between the same pair of holes, adjusting at least one of a first optical magnification of the first interferometer channel or a second optical magnification of the second interferometer channel based on the comparison result, defining a distortion map for each of the first and second intensity frames based on said comparison of the locations of the plurality of holes, generating an extended distortion map for each of the first and second intensity frames by map fitting the distortion map, and utilizing the extended distortion map for each of the first and second intensity frames to reduce at least one of a registration error or an optical distortion in a subsequent measurement process.

A further embodiment of the present disclosure is directed to an interferometer system. The interferometer system includes first and second spaced apart reference flats having corresponding first and second parallel reference surfaces forming a cavity therebetween, first and second interferometer devices located on diametrically opposite sides of the cavity, first and second interferogram detectors, and one or more processing unit coupled to receive the outputs of the first and second interferogram detectors. The processing unit is configured for performing a method for calibrating the interferometer system based on first and second intensity frames of a calibration wafer obtained from the first and second interferogram detectors. The calibration method includes determining locations of the plurality of holes based on the first intensity frame, determining locations of the plurality of holes based on the second intensity frame, comparing the locations of the plurality of holes determined based on the first intensity frame and the locations of the plurality of holes determined based on the second intensity frame against the locations of the plurality of holes measured utilizing an external measurement device, adjusting at least one of a first optical magnification of the first interferometer channel or a second optical magnification of the second interferometer channel at least partially based on the comparison, defining a distortion map for each of the first and second intensity frames based on the comparison of the locations of the plurality of holes, generating an extended distortion map for each of the first and second intensity frames by map fitting the distortion map, and utilizing the extended distortion map for each of the first and second intensity frames to reduce at least one of a registration error or an optical distortion in a subsequent measurement process.

A further embodiment of the present disclosure is directed to a method for measuring shape and thickness variation of a notchless wafer utilizing a calibration wafer for registration. The calibration wafer with a plurality of circular reference shapes defined thereof is placed into a measurement cavity. Two sets of intensity frames that record interferograms from two interferometer channel are acquired and are used to determine center locations of the holes defined on the calibration wafer as seen by each interferometer detector. These center locations are then utilized for registration purposes for subsequent measurement of a notchless wafer.

A further embodiment of the present disclosure is directed to a method for measuring shape and thickness variation of a notchless wafer utilizing one or more reference plates. The one or more reference plates are placed within the measurement cavity and utilized to register the front and the back surfaces of the notchless wafer. In this manner, the front and the back surfaces with the shape boundary, including the wafer boundary and the boundary from reference plates, are utilized jointly for the registration process.

An embodiment of the present invention is directed to a method to improve the accuracy of a wafer measurement system by reducing the registration error or the location mismatch of the front and the back of the wafer surfaces. In addition, a calibration process may be utilized to reduce the optical geometric distortion and/or match of the optical magnification of the Fizeau interferometers used in the measurement system. While the technique described here refers mainly to wafers, it is to be understood that the technique also is applicable to other types of polished plates as well.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a diagrammatic representation of an interferometer system for measuring shape and thickness variation of a wafer;

FIG. 2 is an illustration depicting a calibration wafer;

FIG. 3 is a flow diagram illustrating a method for calibrating the interferometer system utilizing a calibration wafer;

FIG. 4 is an illustration depicting another calibration wafer;

FIG. 5 is a flow diagram illustrating a method for measuring shape and thickness variation of a notchless wafer utilizing a calibration wafer for registration;

FIG. 6 is an illustration depicting a thin plate utilized for registration; and

FIG. 7 is a flow diagram illustrating a method for measuring shape and thickness variation of a notchless wafer utilizing the thin plate for registration.

### DETAILED DESCRIPTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspect. Also, it is to be understood that the invention is not limited in its application to the details of construction and the arrangement of the components set forth in the following description or illustrated in the drawings. The invention is applicable to other embodiments or of being practiced or carried out in various ways and is intended to include various modifications and equivalent arrangements within the spirit and scope of the appended claims.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

In the below description, an embodiment is an example or implementation of the invention. The various appearances of “one embodiment”, “an embodiment”, “certain embodiments” or “some embodiments” do not necessarily all refer to the same embodiments.

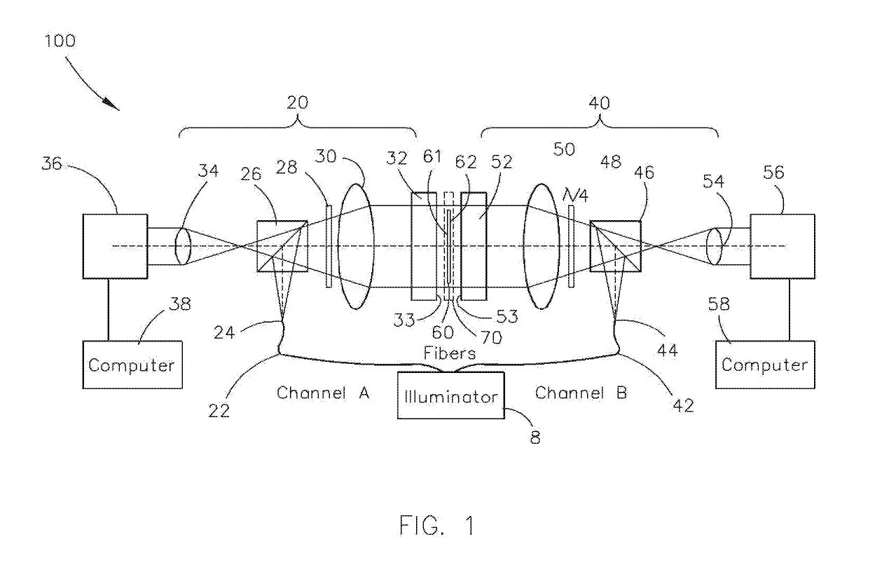

Referring to FIG. 1, a block diagram depicting measurement system 100 that utilizes two Fizeau interferometers is shown. As depicted in FIG. 1, measurement system 100 is configured for measuring the shape and thickness of wafer 60. Wafer 60 may be placed in a cavity in the center between two Fizeau interferometers 20 and 40. Reference flats 32 and 52 of the interferometers are placed close to wafer 60.

Measurement system 100 provides two light sources for Channel A and Channel B through fiber 22 and fiber 42 from a single illuminator 8 that generates a constant power output during its wavelength tuning. In an example embodiment, light source 24, 44 provides light that passes through quarter-wave plate 28, 48 aligned at 45° to the polarization direction of light after it is reflected from polarizing beam splitter 26, 46. This beam then propagates to lens 30, 50 where it is collimated with a beam diameter larger than the wafer diameter.

The beam then goes through transmission flat 32, 52 where the central part of the transmitted beam is reflected at test surface 61, 62 that forms an interferogram with the light beam reflected from reference surface 33, 53. The outer part of the transmitted beam travels on to opposite reference flat 52, 32, where it is reflected at reference surface 53, 33 that forms an annular shape interferogram with the light beam reflected from reference surface 33, 53. Interferogram detectors (e.g., an imaging device such as a camera or the like) 36, 56 are utilized to record the interferograms and send the interferograms to computer 38, 58 for processing to produce the desired information such as the shape and the thickness variation of a wafer.

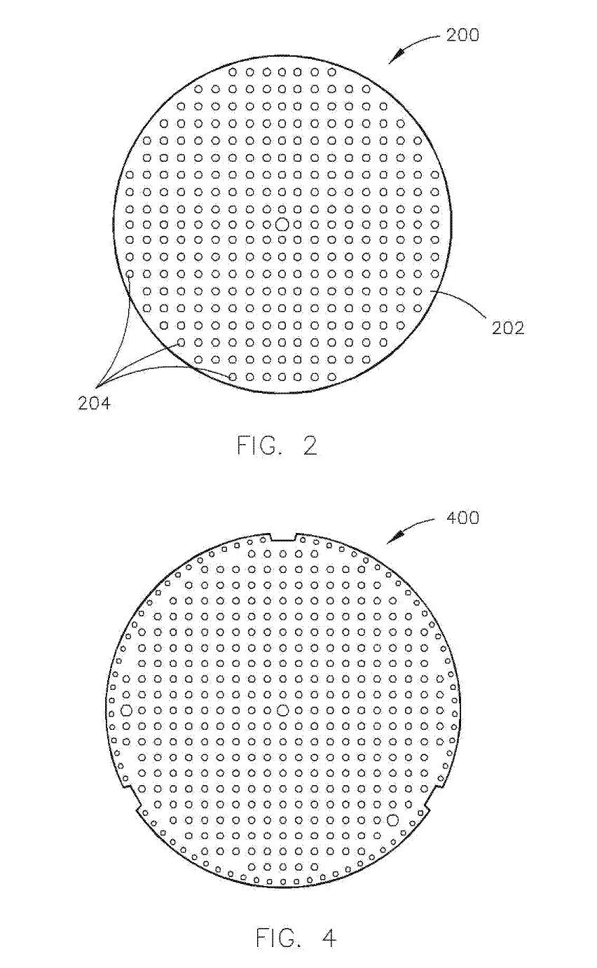

In accordance with an example embodiment of the present disclosure, a see-through calibration wafer 200 as depicted in FIG. 2 is utilized to calibrate the wafer measurement system. More specifically, see-through calibration wafer (or simply referred to as the calibration wafer) 200 is opaque wafer 202 with holes 204 defined therein. Calibration wafer 200 may be inserted into the cavity formed by reference flat 32 and 52 as depicted in FIG. 1 for calibration purposes. Holes 204 defined in this manner provide reference locations that can be compared to improve the accuracy of the wafer measurement system.

For instance, one of the main advantages of using such a calibration wafer 200 is that holes 204 can be seen from both Channel A and Channel B at the same time. Thus the relative position of each hole on two interferogram detectors can be obtained directly with high accuracy. This is crucial for computing the wafer thickness since any relative position shift between the surface from Channel A and the surface from Channel B results in large thickness calculation errors and needs to be mitigated. Another advantage of using calibration wafer 200 is that the center positions of holes 204 (which are used as reference points) can be determined much more accurately than just the camera pixel resolution. Thus any small optical geometric distortion can be determined more accurately using such reference points than using camera pixel resolution itself.

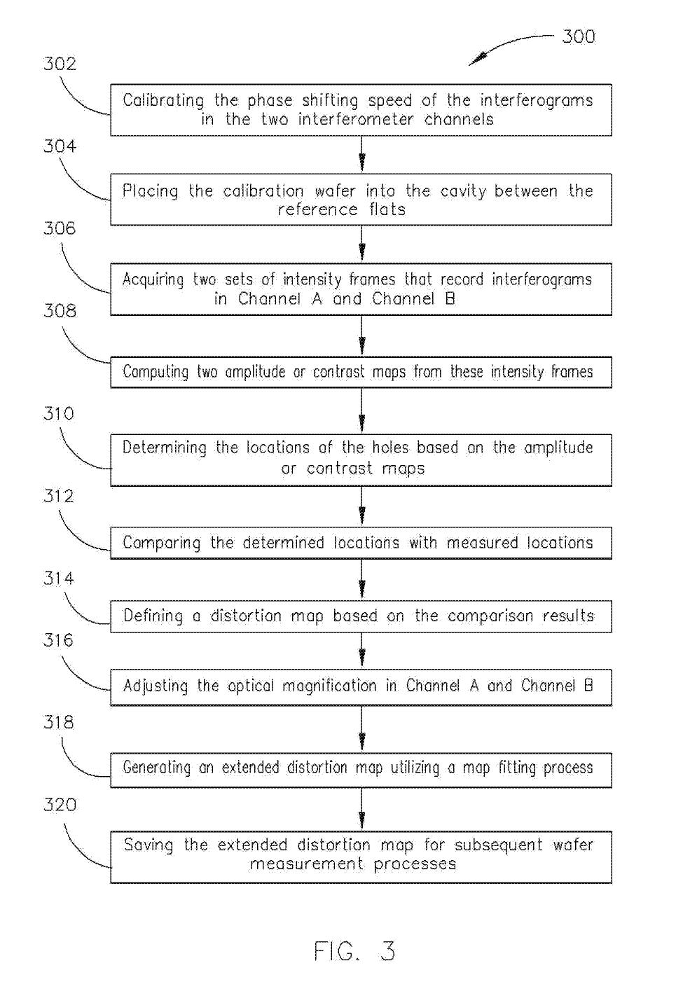

Referring to FIG. 3, method 300 for improving measurement accuracy of the wafer thickness variation by reducing the registration error of the front and back surfaces is shown. Step 302 first calibrates the phase shifting speed of the interferograms in the two interferometer channels. In an example embodiment, the phase shifting speed of the interferograms are calibrated by placing a polished opaque plate in the cavity between reference flats 32 and 52. Alternatively, the phase shifting speed calibration may be conducted by the cavity itself (without the polished opaque plate). Upon completion of the phase shift calibration, or when the phase shift between any adjacent frames is within ±1 degree or less of its expected value such as 90 degrees for the phase shift between any adjacent frames, the method may proceed to step 304.

In step 304, the calibration wafer as described above is placed into the cavity between reference flats 32 and 52. Step 306 then acquires two sets of intensity frames that record interferograms in Channel A and Channel B by varying the wavelength of the light source. Two amplitude or contrast maps from these intensity frames may then be computed in step 308, one map for each channel, and these amplitude/contrast maps may be used in step 310 to determine the locations of the circles (e.g., circle centers) that correspond to the holes defined in the calibration wafer.

It is contemplated that the precise center locations of the holes defined in the calibration wafer may be known/measured using an external mechanical and/or optical measurement device/equipment prior to the placement of the calibration wafer into the cavity. Such center location information may therefore be utilized as reference values and the center locations of the circles determined in step 310 may be compared against these reference values in step 312. Performing such comparisons help the calibration process to determine the distortions that may exist, and step 314 may subsequently define a distortion map based on the comparison results.

In an example embodiment, the distortion map is defined in pixel coordinates of the intensity frame. The distortion map contains information regarding the relative rotations and center locations of the holes between the measurements taken in step 310 and the reference values. Such information may then be used during the conversion from the pixel coordinates to wafer coordinates.

For instance, step 316 may adjust the optical magnification (um/pixel) in Channel A and Channel B such that the physical distance between any given two circles/holes calculated in Channel A is the same as that calculated in Channel B. More specifically, after the optical system in each channel is setup, the optical system itself is fixed but the optical magnification value M in each channel may be adjusted. The value of the optical magnification M_{A} (in Channel A) or M_{B} (in Channel B) can be adjusted such that the distance d_{A} or d_{B} of any two circle hole centers computed from each channel is the same to their true physical distance dₚ on the calibration wafer. That is, for a pair of holes defined in the calibration wafer, given d_{A}=P_{A}×M_{A} and d_{B}=P_{B}×M_{B}, where P_{A} and P_{B} are the pixels measured in Channel A and Channel B, respectively, ideally the equation d_{A}=d_{B}=dₚ should be true. Therefore, step 316 may compare the calculated distance d_{A} and d_{B} against the measured distance dₚ for the same pair of holes and adjust the optical magnification in Channel A and/or Channel B so that the equation d_{A}=d_{B}=dₚ is satisfied.

It is contemplated that the two holes selected for performing this operation may be predetermined or chosen arbitrarily. Additionally and/or alternatively, step 316 may be carried out multiple times using different pair of holes each time. However, due to the measurement errors and optical distortions, d_{A}=d_{B}=dₚ may not be satisfied for the distances calculated from all pairs of holes at the same time. Therefore, if step 316 is carried out for multiple pairs, the values of M_{A} and M_{B} should be defined such that the overall error is minimized. It is contemplated that the particular holes selected for performing the adjustment, and the number of times such adjustments are performed, may various without departing from the spirit and scope of the present disclosure.

One advantage of using the calibration wafer to providing and adjust the optical magnification in Channel A and Channel B as described above is to allow the rest of the wafer measurement process to be performed based on the physical wafer locations as opposed to the camera pixel locations. In addition, another advantage of using the calibration wafer is that it can be used to calibrate the optical distortions as well. That is, using the calibration wafer in accordance with the present disclosure, the center positions of the holes can be determined much more accurately than the wafer boundary extracted on the oversized cavity area from both channels to register the front and the back side of wafer surfaces. This allows optical geometric distortions to be determined more accurately.

More specifically, the locations of the holes determined based on the intensity frame obtained in Channel A and the locations of the holes determined based on the intensity frame obtained in Channel B are compared against the actual (measured) locations of the these holes in step 312 to obtain the distortion information. Once the distortion information regarding these discrete points defined by the holes in the calibration wafer is determined, the distortion information/map can be extended to every pixel in the field of view of Channel A and Channel B. In an example embodiment, map fitting techniques, such as least square fitting processes, may be used in step 318 to extend the distortion map. For instance, two distortion maps (e.g., using two dimensional fitting) may be defined for each of Channel A and Channel B. For each channel, one distortion map may be generated to describe the distortion in the x-direction and the other distortion map may be generated to describe the distortion in the y-direction. The extended distortion maps may then be saved in step 320 for future references.

It is contemplated that the extended distortion maps may be utilized to reduce registration errors or location mismatches, providing improved registration for the front and the back side of wafer surfaces during wafer measurement. While existing wafer measurement methods use wafer boundary locations and notch locations to match the relative position of surfaces from Channel A and Channel B (i.e., the front and the back side of wafer surfaces), such registrations may be inaccurate both in the rotational direction since the wafer is a circular shape and the notch is very small, and in the x-y direction since the wafer center is determined by the wafer edge that may be misplaced by the optical geometric distortion. It is contemplated that geometric distortions can be determined more accurately using the extended distortion maps in accordance with the present disclosure. That is, the same measurement procedures may be performed except that the distortion maps generated in accordance with the present disclosure are used to reduce registration errors and location mismatches of the front and back surfaces.

Accordingly, once the measurement system is calibrated as described in method 300, wafer 60 that is to be measured may be placed in the cavity. Wafer 60 may be placed in between two Fizeau interferometers 20 and 40 (more specifically, between reference flats 32 and 52). A holding container may be utilized to removably secure wafer 60 when wafer 60 is placed in the cavity. The holding container may be configured in a manner such that both wafer sides 61 and 62 are minimally obscured by the holding container.

Subsequently, two sets of intensity frames that record interferograms in Channel A and Channel B with different phase shifts by varying the wavelength of light source 8 may be acquired. The phases and phase shifts of interferograms from these intensity frames may be extracted and the shape and thickness information may be computed based on the phases and phase shifts of interferograms extracted. In an example embodiment, the shape and thickness information may be computed in a manner similar to that disclosed in U.S. Pat. No. 6,847,458. For instance, let A denote the phase of interferogram formed by reference flat 32 and wafer surface 61, let B denote the phase of interferogram formed by reference flat 53 and wafer surface 62, and let C denote the phase of interferogram formed by the cavity of two reference flats 32 and 53. Thus A provides information regarding the height of wafer surface 61, B provides information regarding the height of wafer surface 62, and C-(A+B) provides information regarding the thickness variation of wafer 60.

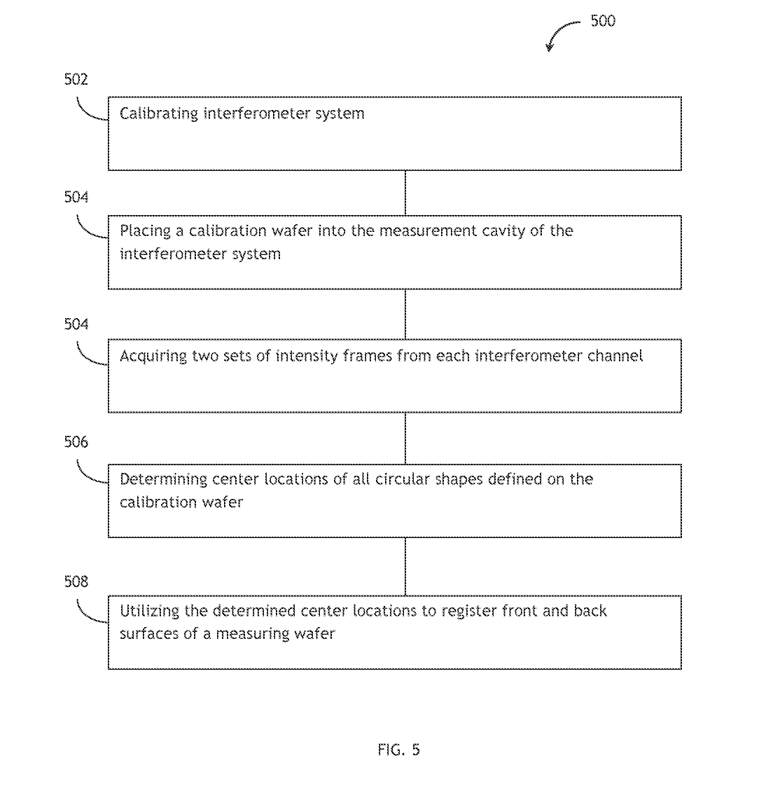

It is contemplated that calibration wafer 200 depicted in FIG. 2 is merely exemplary. For instance, FIG. 4 shows calibration wafer 400 having an extended edge (greater than the wafer diameter) with holes defined therein. The purpose of using extended calibration wafer 400 is to put holes as close as possible to the measuring wafer edge position in order to minimize the distortion map at the wafer edge location. In other words, the holes defined in the calibration wafer are spread over an area that is as large as possible. It is also contemplated, however, that the holes defined on the calibration wafers are not required to form any particular patterns. That is, holes may be randomly distributed or scattered/spread over the entire calibration wafer. Furthermore, the size and the shape of holes can vary without departing from the spirit and scope of the present disclosure.

It is also contemplated that while steps 306 and 308 described above compute amplitude or contrast maps from interferograms obtained in Channel A and Channel B to determine the center locations of the holes defined in the calibration wafer, various other techniques may be utilized without departing from the spirit and scope of the present disclosure. For instance, a video frame without the cavity interferogram may be acquired by swiping the laser wavelength, and step 310 may determine the center/edge locations of the holes directly from the video frame.

It is contemplated that the calibration method in accordance with the present disclosure not only helps calibrating/adjusting the optical magnification of the interferometers used in the measurement system, but also improves the registration accuracy. In accordance with the present disclosure, matching the relative positions of surfaces from Channel A and Channel B is not based on wafer boundary locations and notch locations, but is explicitly calibrated using the calibration wafer to provide precise registration information for Channel A and Channel B, therefore improving the measurement accuracy of the measurement system.

For instance, the see-through calibration wafers as depicted above may be particularly useful for measurement of notchless wafers. Since existing wafer measurement methods use wafer boundary locations and notch locations to match the relative position of surfaces from Channel A and Channel B (i.e., the front and the back side of wafer surfaces), such registrations are not applicable for measurement of wafers that do not have notches (i.e., notchless wafers). It is noted that while a notchless wafer does not have a notch to define the areas for computing metrics, it has one or more marks on at least one side, typically the back side, of the wafer. These marks can therefore be utilized to determine the angular direction of the back side of the wafer. It is also noted, however, that the demanding measuring metrics may need to be calculated from an area related to or specified on the front side of the wafer. To define the metric area by marks only on the back side of wafer, the relative position of the surfaces on the front side and the back side of the wafer must be determined, i.e., registered. In accordance with the present disclosure, the calibration wafers as depicted above can be utilized to register the front side and the back side of a notchless wafer.

More specifically, the see-through calibration wafers as depicted above can be used to calibrate the relative position of two cameras depicted in FIG. 1. In an example embodiment, when calibration wafer 200 is inserted into the cavity formed by reference flats 32 and 52, the center location of holes recorded on both camera 36 and camera 56 can be determined by least square fitting the edge pixel locations of each hole. Due to the circular boundary of each hole, the center location can be determined very accurately, much better than the camera pixel resolution. Subsequently, all center locations as detected by each camera are compared with the corresponding known center locations of the holes on the calibration wafer to determine relative camera positions. Such relative camera positions are used in the wafer measurement to align the front wafer surface to the back wafer surface.

It is contemplated that other types of calibration wafers may also be utilized in addition to a see-through type calibration wafer without departing from the spirit and scope of the present disclosure, as long as the calibration wafer defines a plurality of circular reference shapes thereof. For instance, a transparent glass/quartz wafer with reflective or opaque circles or other alignment features deposited on one side and with anti-reflection coating on the other side may be used in a similar manner. In this case the reflective or opaque circles can be detected by both cameras, just as through the holes, and used to extract all necessary position/orientation information.

FIG. 5 is a flow diagram illustrating method 500 for measuring shape and thickness variation of a notchless wafer utilizing a calibration wafer. The interferometer system may be calibrated first in step 502. Calibrating the interferometer system may include the steps of calibrating the phase shifting speed by placing a polished opaque plate in a cavity formed between reference flats or by the cavity itself and/or calibrating the cavity characteristics of the reference flats. Subsequently, a calibration wafer as described above can be placed into the cavity formed by the reference flats in step 504. Two sets of intensity frames that record interferograms from each interferometer channel are then acquired in step 506 by varying the wavelength of the light source. Two amplitude or contrast maps from these intensity frames, one for each interferometer, can then be calculated and used in step 508 to determine center locations of all the circles defined on the calibration wafer as seen by each interferometer detector. These center locations can then be stored for subsequent measurement of a notchless wafer.

As illustrated in FIG. 5, once the center locations are determined and stored, a wafer to be measured by the interferometer system (this wafer is referred to as the measuring wafer) can be placed in the cavity in the center or off-center between two Fizeau interferometers, A and B, such that both wafer sides 61 and 62 are minimally obscured by the holding container. Two sets of intensity frames that record interferograms in interferometer A and interferometer B with different phase shifts by varying the wavelength of the light source are acquired, and phases and phase shifts of interferograms from these intensity frames are then extracted. The center locations determined in step 508 can be utilized to register the front and the back surface phase maps in step 510, and the shape and thickness information may be computed subsequently in a manner similar to the calculation process previously described.

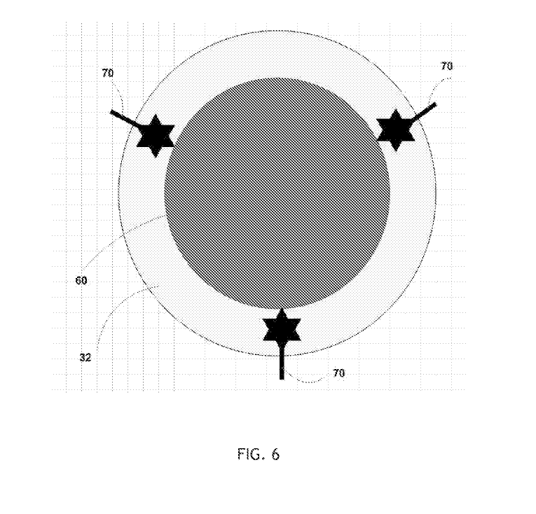

It is contemplated that in addition/alternative to the calibration wafers, reference plates as illustrated in FIG. 6 may also be utilized to facilitate registration of notchless wafers. As depicted in FIG. 6, one or more reference plates 70 are placed in the cavity formed by reference flats 32 and 52. Such reference plates 70 can be inserted intentionally for surface registration after the measuring wafer is placed within the cavity. Alternatively, existing mechanical wafer handling features in the oversized cavity area may define such reference plates 70 and place them in the cavity automatically. It is understood that various other mechanisms may be utilized to define, place or insert such reference plates 70 within the measurement cavity without departing from the spirit and scope of the present disclosure.

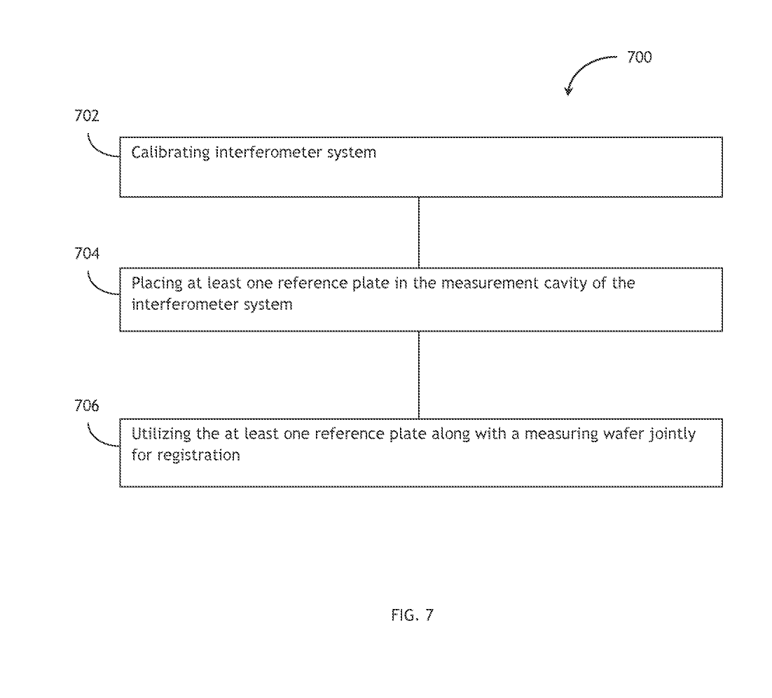

FIG. 7 is a flow diagram illustrating a method 700 for measuring shape and thickness variation of a notchless wafer utilizing reference plates. The interferometer system may be calibrated first in step 702. Subsequently, a wafer to be measured by the interferometer system can be placed in the cavity in the center or off-center between two Fizeau interferometers, A and B, such that both wafer sides 61 and 62 are minimally obscured by the holding container. Two sets of intensity frames that record interferograms in interferometer A and interferometer B with different phase shifts by varying the wavelength of the light source are acquired, and phases and phase shifts of interferograms from these intensity frames are then exacted. The reference plates placed within the cavity can then be utilized to register the front and the back surface phase maps in step 704. The reference plates are placed in positions within the cavity such that they are visible in the cavity but do not obscure the front and back surfaces of the measuring wafer. In this manner, the front and back surface phase maps with the shape boundary, including the wafer boundary and the boundary from reference plates, are utilized jointly for the registration process in step 706. Subsequently, the shape and thickness information may be computed in a manner similar to the calculation process previously described.

It is contemplated that while the examples above referred to wafer metrology measurements, the systems and methods in accordance with the present disclosure are applicable to other types of polished plates as well without departing from the spirit and scope of the present disclosure. The term wafer used in the present disclosure may include a thin slice of semiconductor material used in the fabrication of integrated circuits and other devices, as well as other thin polished plates such as magnetic disc substrates, gauge blocks and the like.

It is to be understood that the present disclosure may be implemented in forms of a software/firmware package. Such a package may be a computer program product which employs a computer-readable storage medium/device including stored computer code which is used to program a computer to perform the disclosed function and process of the present disclosure. The computer-readable medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions.

The methods disclosed may be implemented as sets of instructions, through a single production device, and/or through multiple production devices. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the disclosure. The accompanying method claims present elements of the various steps in a sample order, and are not necessarily meant to be limited to the specific order or hierarchy presented.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention as claimed.

What is claimed is:

1. An interferometer system, comprising:
first and second spaced apart reference flats having corresponding first and second parallel reference surfaces forming a cavity therebetween;
first and second interferometer devices located on diametrically opposite sides of the cavity;
first and second interferogram detectors; and,
at least one processing unit coupled to receive outputs of the first and second interferogram detectors, the at least one processing unit configured for performing a method for calibrating the interferometer system based on first and second intensity frames of a calibration wafer obtained from the first and second interferogram detectors, the method comprising:
a) determining first locations of a plurality of holes based on the first intensity frame;
b) determining second locations of the plurality of holes based on the second intensity frame;
c) comparing the first locations of the plurality of holes determined based on the first intensity frame and the second locations of the plurality of holes determined based on the second intensity frame against first measured locations of the plurality of holes measured utilizing an external measurement device;
d) adjusting at least one of: a first optical magnification of a first interferometer channel or a second optical magnification of a second interferometer channel at least partially based on said comparison;
e) defining a first distortion map for each of the first and second intensity frames based on said comparison;
f) generating an extended distortion map for each of the first and second intensity frames by map fitting the first distortion map defined in step e); and,
g) utilizing the extended distortion map for each of the first and second intensity frames to reduce at least one of: a registration error or an optical distortion in a subsequent measurement process.

2. The interferometer system of claim 1, wherein the adjusting step further comprises:
h) calculating a first distance between a pair of holes of the plurality of holes based on the first intensity frame;
i) calculating a second distance between the pair of holes based on the second intensity frame;
j) comparing the first calculated distance and the second calculated distance against a first measured distance between the pair of holes; and,
k) adjusting at least one of: the first optical magnification of the first interferometer channel or the second optical magnification of the second interferometer channel based on said comparison.

3. The interferometer system of claim 2, wherein said at least one of: the first optical magnification or the second optical magnification is adjusted such that the first distance between the pair of holes calculated based on the first intensity frame utilizing the first optical magnification is equal to the second distance between the pair of holes calculated based on the second intensity frame utilizing the second optical magnification.

4. The interferometer system of claim 2, wherein the method further comprises:
l) calculating a third distance between a second pair of holes of the plurality of holes based on the first intensity frame;
m) calculating a fourth distance between the second pair of holes based on the second intensity frame;
n) comparing the third calculated distance and the fourth calculated distance against a second measured distance between the second pair of holes; and,
o) adjusting at least one of: the first optical magnification of the first interferometer channel or the second optical magnification of the second interferometer channel wherein an overall error is minimized.

5. The interferometer system of claim 1, wherein the first distortion map for each of the first and second intensity frames includes distortion information describing the optical distortion in an x-direction and in a y-direction.

6. The interferometer system of claim 1, wherein the extended distortion map for each of the first and second intensity frames is configured for providing distortion information for an entirety of a field of view of the first and second intensity frames, respectively.

7. An interferometer system, comprising:
first and second spaced apart reference flats having corresponding first and second parallel reference surfaces forming a cavity therebetween;
first and second interferometer devices located on diametrically opposite sides of the cavity;
first and second interferogram detectors; and,
at least one processing unit coupled to receive outputs of the first and second interferogram detectors, the at least one processing unit configured to:
acquire a first intensity frame of a calibration wafer from a first interferometer channel and acquiring a second intensity frame of the calibration wafer from a second interferometer channel, wherein the calibration wafer defines a plurality of circular shapes therein;
determine locations of the plurality of circular shapes based on the first intensity frame of the calibration wafer and the second intensity frame of the calibration wafer;
acquire a third intensity frame of a measuring wafer from the first interferometer channel and acquiring a fourth intensity frame of the measuring wafer from the second interferometer channel; and,
register relative positions of the third intensity frame of the measuring wafer and the fourth intensity frame of the measuring wafer based on the determined locations of the plurality of circular shapes.

8. The interferometer system of claim 7, wherein the at least one processing unit is further configured to:
measure a thickness variation and a shape of the measuring wafer based on the first intensity frame of the measuring wafer and the second intensity frame of the measuring wafer.

9. The interferometer system of claim 7, wherein the at least one processing unit is further configured to:
utilize at least one reference plate placed within the cavity with the measuring wafer to further facilitate registration of the first intensity frame of the measuring wafer and the second intensity frame of the measuring wafer.

10. A method for calibrating an interferometer system, the interferometer system including a cavity formed between reference flats in a first interferometer channel and a second interferometer channel, the method comprising:
a) placing a calibration wafer in the cavity, the calibration wafer defining a plurality of holes therein;
b) acquiring a first intensity frame from the first interferometer channel;
c) acquiring a second intensity frame from the second interferometer channel;
d) determining first locations of the plurality of holes based on the first intensity frame;
e) determining second locations of the plurality of holes based on the second intensity frame;
f) calculating a first distance between a first pair of holes of the plurality of holes based on the first intensity frame;
g) calculating a second distance between the first pair of holes based on the second intensity frame;
h) comparing the first calculated distance and the second calculated distance against a first measured distance between the first pair of holes;
i) adjusting at least one of: a first optical magnification of the first interferometer channel or a second optical magnification of the second interferometer channel based on said comparison in step h);
j) defining a first distortion map for each of the first and second intensity frames based on said comparison of the first and second locations of the plurality of holes;
k) generating an extended distortion map for each of the first and second intensity frames by map fitting the first distortion map defined in step h); and,
l) utilizing the extended distortion map for each of the first and second intensity frames to reduce at least one of: a registration error or an optical distortion in a subsequent measurement process.

11. The method of claim 10, wherein the first measured distance is predetermined.

12. The method of claim 10, wherein the first distance, the second distance, and the first measured distance between the first pair of holes is determined by a center-to-center distance.

13. The method of claim 10, wherein said at least one of: the first optical magnification or the second optical magnification is adjusted such that the first distance between the first pair of holes calculated based on the first intensity frame utilizing the first optical magnification is equal to the second distance between the first pair of holes calculated based on the second intensity frame utilizing the second optical magnification.

14. The method of claim 10, further comprising:
m) calculating a third distance between a second pair of holes of the plurality of holes based on the first intensity frame;
n) calculating a fourth distance between the second pair of holes based on the second intensity frame;
o) comparing the third calculated distance and the fourth calculated distance against a second measured distance between the second pair of holes; and,
adjusting at least one of: the first optical magnification of the first interferometer channel or the second optical magnification of the second interferometer channel wherein an overall error is minimized.

15. The method of claim 10, wherein the first distortion map for each of the first and second intensity frames includes distortion information describing the optical distortion in an x-direction and in a y-direction.

16. A method for calibrating an interferometer system, the interferometer system including a cavity formed between reference flats in a first interferometer channel and a second interferometer channel, the method comprising:
a) placing a calibration wafer in the cavity, the calibration wafer defining a plurality of holes therein;
b) acquiring a first intensity frame from the first interferometer channel;
c) acquiring a second intensity frame from the second interferometer channel;
d) determining first locations of the plurality of holes based on the first intensity frame;
e) determining second locations of the plurality of holes based on the second intensity frame;
f) comparing the first locations of the plurality of holes determined based on the first intensity frame and the second locations of the plurality of holes determined based on the second intensity frame against measured locations of the plurality of holes measured utilizing an external measurement device;
g) adjusting at least one of: a first optical magnification of the first interferometer channel or a second optical magnification of the second interferometer channel at least partially based on said comparing step;
h) defining a first distortion map for each of the first and second intensity frames based on said comparing step;
i) generating an extended distortion map for each of the first and second intensity frames by map fitting the first distortion map defined in step h); and,
j) utilizing the extended distortion map for each of the first and second intensity frames to reduce at least one of: a registration error or an optical distortion in a subsequent measurement process.

17. The method of claim 16, wherein the adjusting step comprises:
k) calculating a first distance between a first pair of holes of the plurality of holes based on the first intensity frame;
l) calculating a second distance between the first pair of holes based on the second intensity frame;
m) comparing the first calculated distance and the second calculated distance against a first measured distance between the first pair of holes; and,
n) adjusting at least one of: the first optical magnification of the first interferometer channel or the second optical magnification of the second interferometer channel based on said comparison in step m).

18. The method of claim 17, wherein the first distance, the second distance, and the first measured distance between the first pair of holes is a center-to-center distance.

19. The method of claim 17, wherein said at least one of: the first optical magnification or the second optical magnification is adjusted such that the first distance between the first pair of holes calculated based on the first intensity frame utilizing the first optical magnification is equal to the second distance between the first pair of holes calculated based on the second intensity frame utilizing the second optical magnification.

20. The method of claim 17, further comprising:
o) calculating a third distance between a second pair of holes of the plurality of holes based on the first intensity frame;
p) calculating a fourth distance between the second pair of holes based on the second intensity frame;
q) comparing the third calculated distance and the fourth calculated distance against a second measured distance between the second pair of holes; and,
r) adjusting at least one of: the first optical magnification of the first interferometer channel or the second optical magnification of the second interferometer channel wherein an overall error is minimized.

21. The method of claim 16, wherein the first distortion map for each of the first and second intensity frames includes distortion information describing the optical distortion in an x-direction and in a y-direction.

22. The method of claim 16, wherein the extended distortion map for each of the first and second intensity frames is generated utilizing a least square fitting process.

23. The method of claim 16, wherein the extended distortion map for each of the first and second intensity frames is configured for providing distortion information for an entirety of a field of view of the first and second intensity frames, respectively.

24. A method for wafer measurement, the method comprising:
calibrating characteristics of a cavity formed between reference flats in two opposing interferometer channels;
placing a calibration wafer in the cavity, the calibration wafer defining a plurality of circular shapes therein;
acquiring a first intensity frame of the calibration wafer from the first interferometer channel and acquiring a second intensity frame of the calibration wafer from the second interferometer channel;
determining locations of the plurality of circular shapes based on the first intensity frame of the calibration wafer and the second intensity frame of the calibration wafer;
placing a measuring wafer in the cavity;
acquiring a third intensity frame of the measuring wafer from the first interferometer channel and acquiring a fourth intensity frame of the measuring wafer from the second interferometer channel; and,
registering relative positions of the third intensity frame of the measuring wafer and the fourth intensity frame of the measuring wafer based on the determined locations of the plurality of circular shapes.

25. The method of claim 24, wherein the wafer is a notchless wafer.

26. The method of claim 24, further comprising:
measuring a thickness variation and a shape of the measuring wafer based on the third intensity frame of the measuring wafer and the fourth intensity frame of the measuring wafer.

27. The method of claim 24, further comprising:
utilizing at least one reference plate placed within the cavity with the measuring wafer to further facilitate registration of the third intensity frame of the measuring wafer and the fourth intensity frame of the measuring wafer.

28. A method for wafer measurement, the method comprising:
calibrating characteristics of a cavity formed between reference flats in two opposing interferometer channels;
placing a measuring wafer in the cavity;
placing at least one reference plate in the cavity;
acquiring a first intensity frame from the first interferometer channel and acquiring a second intensity frame from the second interferometer channel; and,
registering relative positions of the first intensity frame and the second intensity frame based on at least one position of the at least one reference plate.

29. The method of claim 28, wherein the wafer is a notchless wafer.

30. The method of claim 28, further comprising:
measuring a thickness variation and a shape of the measuring wafer based on the first intensity frame and the second intensity frame.
